(19) United States
(12) Patent Application Publication
(10) Pub. No.: US 2007/0230061 A1
(43) Pub. Date: Oct. 4, 2007

(54) Method for fabricating magnetic head

(75) Inventors: Hiroshi Endo, Kawasaki (JP); Yasuhiro Wakabayashi, Kawasaki (JP); Shin Eguchi, Kawasaki (JP); Tamotsu Yamamoto, Kawasaki (JP); Ei Yano, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/727,659

(22) Filed: Mar. 27, 2007

Related U.S. Application Data
(63) Continuation-in-part of application No. 11/453,948, filed on Jun. 15, 2006.

(30) Foreign Application Priority Data
Mar. 28, 2006 (JP) 2006-087206
Feb. 16, 2007 (JP) 2007-036172

(51) Int. Cl. G11B 5/127

(52) U.S. Cl. 360/313

(57) ABSTRACT

The method for fabricating the magnetic head comprises the step of forming over a lower electrode a magnetoresistive effect film 16 with a polishing resistant film 20 formed over the upper surface, the step of forming a magnetic domain control film 24 over the entire surface of the lower electrode 12 including a region where the magnetoresistive effect film 16 has been formed, the step of selectively removing the magnetic domain control film 24 over the magnetoresistive effect film 16 by polishing with the polishing resistant film 20 as the stopper, the step of removing the polishing resistant film 20, and the step of forming an upper electrode 34 over the magnetoresistive effect film 16, from which the polishing resistant film 20 has been removed.

### CROSS-REFERENCE TO RELATED APPLICATIONS

This application is a continuation-in-part of Ser. No. 11/452,948, filed Jun. 15, 2006.

This application is based upon and claims the benefit of priorities from the prior Japanese Patent Application No. 2006-087206, filed on Mar. 28, 2006, and the prior Japanese Patent Application No. 2007-036172, filed on Feb. 16, 2007, the entire contents of which are incorporated herein by reference.

### BACKGROUND OF THE INVENTION

The present invention relates to a method for fabricating a magnetic head, more specifically, a method for fabricating a magnetic head having the CPP (Current Perpendicular to Plane) structure, which uses the so-called spin valve film and flows a sense current in film thickness-wise direction.

A magnetoresistive effect element using a spin valve film has two magnetic layers one of which has the magnetization direction pinned by a one-direction anisotropic magnetic field, etc. with respect to an anti-ferromagnetic layer and the other of which has the magnetization direction easily changed with respect to an external magnetic field. The property that the element resistance is changed by a relative angle between the magnetization directions of these magnetic layers is utilized to detect a direction of the external magnetic field, based on a change of the element resistance.

As the conventional magnetoresistive effect element using the spin valve film is known the magnetoresistive effect element of the CIP (Current In-Plane) structure which flows a sense current in the in-plane direction of the spin valve film to detect the resistance change.

On the other hand, as a magnetoresistive effect element of higher density and higher sensitivity is noted the magnetoresistive effect element of the CPP (Current Perpendicular to Plane) structure which flows the sense current in the film thickness-wise direction of the spin valve film to detect the resistance change. The magnetoresistive effect element of the CPP structure has a characteristic that as the size is smaller, the device output is increased and is prospective as a reproduction head of high sensitivity of high density magnetic recording device.

Related arts are disclosed in, e.g., Reference 1 (Japanese published unexamined patent application No. Hei 11-185223) and Reference 2 (Japanese published unexamined patent application No. 2004-186673).

As one of the methods for fabricating the magnetic head using the spin valve film is a method of etching a magnetoresistive effect film by ion milling using a two-layer photoresist process and forming a magnetic domain control film and an insulating film by lift-off method. Here, the factors for deciding the core width are the pattern width of the photoresist and the ion milling process. To downsize the core width, it is necessary to make the pattern width of the photoresist small and use a suitable etching process.

In the current process, however, the stable core width is limited to about 100 nm due to limitations, restrictions, etc. of the photoresist forming process and the etching process. It is very difficult to further downsize the core width. The lift-off process often generates burrs, etc. It is difficult to obtain a stable device configuration.

### SUMMARY OF THE INVENTION

An object of the present invention is to provide a method for fabricating a magnetic head having the CPP structure using a spin valve film, which can downsize and control with high precision the read core width and the read gap and can provide a stable device configuration.

According to one aspect of the present invention, there is provided a method for fabricating a magnetic head comprising the steps of: forming over a first region of a lower electrode a magnetoresistive effect film with a first polishing resistant film formed over an upper surface, the first polishing resistant film having a polishing selectivity to a magnetic material; forming a magnetic domain control film over an entire surface of the lower electrode including the first region; removing the magnetic domain control film over the magnetoresistive effect film by polishing with the first polishing resistant film as a stopper to leave the magnetic domain control film selectively in a second region adjacent to the first region; removing the first polishing resistant film; and forming an upper electrode over the magnetoresistive effect film from which the first polishing resistant film has been removed.

According to the present invention, in the method for fabricating a magnetic head using a magnetoresistive effect film, when a magnetic domain control film is deposited over the entire surface of a lower electrode with a magnetoresistive effect film formed on and is polished to thereby be left on both sides of the magnetoresistive effect film, a polishing resistant film is formed over the magnetoresistive effect film, whereby the polish of the region where the magnetoresistive effect film has been formed is prevented in the polishing. Thus, the read gap of the magnetic head can be controlled with high precision.

### BRIEF DESCRIPTION OF THE DRAWINGS

FIG. 1 is a front view of the magnetic head according to a first embodiment of the present invention.

FIGS. 2A-2D, 3A-3C and 4A-4D are sectional views of the magnetic head according to the first embodiment of the present invention in the steps of the method for fabricating the same.

FIGS. 5A-5D are sectional views explaining the role of the polishing resistant film in the method for fabricating the magnetic head according to the first embodiment of the present invention.

FIGS. 6A-6C and 7A-7C are sectional views of the magnetic head according to a second embodiment of the present invention in the steps of the method for fabricating the same.

FIG. 8 is a diagrammatic plan view of the magnetic recording device according to a third embodiment of the present invention.

FIG. 9 is a front view of the magnetic head of the magnetic recording device according to the third embodiment of the present invention.

### DETAILED DESCRIPTION OF THE INVENTION

### A First Embodiment

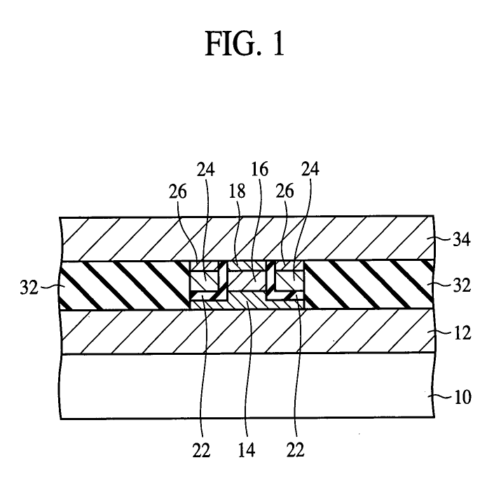

The magnetic head and the method for fabricating the same according to a first embodiment of the present invention will be explained with reference to FIGS. 1 to 5D.

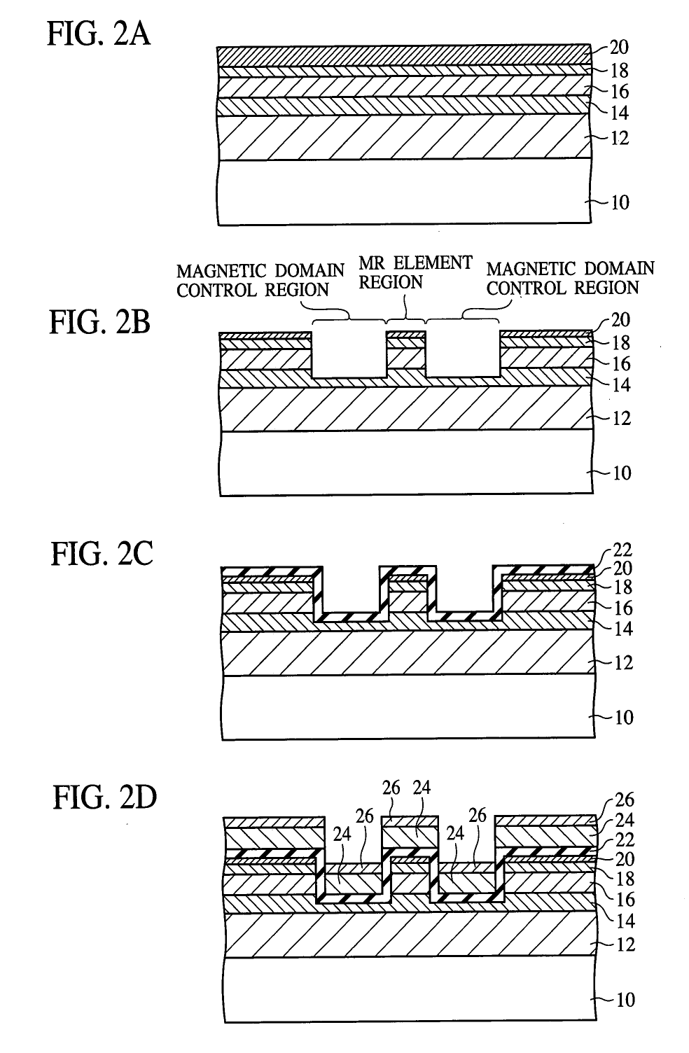

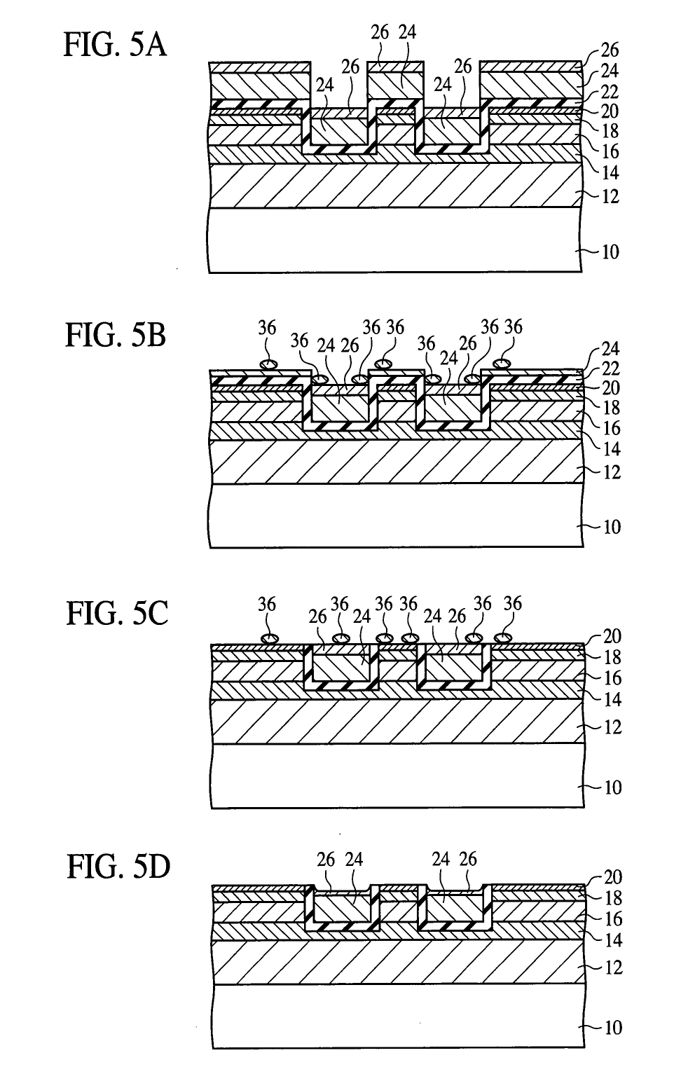

FIG. 1 is a front view of the magnetic head according to the present embodiment. FIGS. 2A to 4D are sectional views of the magnetic head according to the present embodiment in the steps of the method for fabricating the magnetic head. FIGS. 5A-5D are sectional views explaining the role of the polishing resistant film.

First, the structure of the magnetic head according to the present embodiment will be explained with reference to FIG. 1.

On a substrate 10, a lower electrode 12 which functions also as a lower shield is formed. On the lower electrode 12, an etching resistant film 14 of a conductive non-magnetic material, a magnetoresistive effect film 16 of the spin valve structure and a magnetoresistive effect film cap layer 14 of a conductive non-magnetic material are formed. The magnetoresistive effect film 16 and the magnetoresistive effect film cap layer 18 are patterned in a mesa-shape. In the following description, the region where the magnetoresistive effect film 16 and the magnetoresistive effect film cap layer 14 are formed is called an MR (Magnetoresistive) element region (the first region).

On the side walls of the magnetoresistive effect film 16 and the magnetoresistive effect film cap layer 18, a magnetic domain control film 24 for applying a vertical bias magnetic field and a magnetic domain control film cap layer 26 of a conductive non-magnetic material are formed with an insulating film 22 formed therebetween. In the following description, the region where the insulating film 22, the magnetic domain control film 24 and the magnetic domain control film cap layer 26 are formed is called a magnetic domain control region (the second region).

An insulating film 32 is formed on the lower electrode in the region except the MR element region and the magnetic domain control region. An upper electrode 34 which functions also as an upper shield is formed on the magnetoresistive cap layer 18, the magnetic domain control film 26 and the insulating film 32, electrically connected to the magnetoresistive effect film 16 via the magnetoresistive effect film cap layer 18.

Thus, the reproduction magnetic head of the CPP (Current Perpendicular to Plane) structure which flows a sense current through the path of the upper electrode 34—the magnetoresistive effect film cap layer 18—the magnetoresistive effect film 16—the etching resistant film 14—the lower electrode 12 is formed.

In the magnetic head shown in FIG. 1, the width of the magnetoresistive effect film 16 defines the read core width, and the distance between the lower electrode 12 and the upper electrode 34 in the MR element region defines the read gap. It is very important to improve the record density of the magnetic recording device to make the read core width and read gap downsized with high precision.

Then, the method for fabricating the magnetic head according to the present embodiment will be explained with reference to FIGS. 2A to 4D.

First, an NiFe film of, e.g., a 1 μm-thickness is formed on the substrate 10 by, e.g., sputtering method to form the lower electrode 12 of the NiFe film, which functions also as the lower shield.

Then, a Ta film of, e.g., a 30 nm-thickness is formed on the lower electrode 12 by, e.g., sputtering method to form the etching resistant film 14 of the Ta film. The etching resistant film 14 is to be used as the etching stopper film in patterning the magnetoresistive effect film 16 in a later step. In the method for fabricating the magnetic heard according to the present embodiment, the etching resistant film 14 is provided for controlling the etching film thickness in the magnetic domain control region with high precision.

Next, on the etching resistant film 14, the magnetoresistive effect film 16 of the spin valve structure is formed by, e.g., sputtering method. The magnetoresistive effect film 16 is formed by laying, for example, the backing layer of NiFe film, the anti-ferromagnetic layer of PdPtMn, a pinned magnetization layer of the synthetic ferrimagnetic structure of a CoFe film; an Ru film and a CoFe film, a barrier layer of Al₂O₃ film, and a free magnetization layer of NiFe film sequentially one on another. The total film thickness of the thus-formed magnetoresistive effect film 16 is, e.g., 30 nm.

Next, a Ru film of, e.g., a 5 nm-thickness is deposited on the magnetoresistive effect film 16 by, e.g., sputtering method to form the magnetoresistive effect film cap layer 18 of the Ru film.

Then, a Ta film of, e.g., a 30 nm-thickness is deposited on the magnetoresistive effect film cap layer 18 by, e.g., sputtering method to form a polishing resistant film 20 of the Ta film (FIG. 2A). The polishing resistant film 20 is to be used, in later steps, as the etching mask in patterning the magnetoresistive effect film 16 and as the stopper film in CMP (Chemical Mechanical Polish) process for forming the magnetic domain control film 24. To this end, the polishing resistant film 20 is formed of a material having a polishing selectivity with respect to a material forming the magnetic domain control film 24.

Next, a single-layer photoresist film (not shown) is formed on the polishing resistant film 20 by photolithography.

Then, with the photoresist film as the mask, the polishing resistant film 20 is selectively etched by, e.g., reactive ion etching method. The polishing resistant film 20 is etched, e.g., with CF₄ gas with Ar added, at a 20 sccm flow rate of the CF₄ gas and at a 20 sccm flow rate of Ar, with a 200 W source power and a 20 W bias power and at a 1.5 Pa gas pressure. Under these conditions, the etching rate of the polishing resistant film 20 is about 0.85 nm/sec, and the etching rate of the magnetoresistive effect film cap layer 18 is about 0.07 nm/sec. The etching selectivity ratio to the magnetoresistive effect film cap layer 18 can be about 12.

Next, the photoresist film is removed by, e.g., ashing method.

Next, with the patterned polishing resistant film 20 as the mask and the etching resistant film 14 as the stopper, the magnetoresistive effect film cap layer 18 and the magnetoresistive effect film 16 are selectively etched by, e.g., reactive ion etching method (FIG. 2B). In the method for fabricating the magnetic head according to the present embodiment, the magnetoresistive effect film 16 is patterned with a single-layer photoresist used, which allows for higher processing precision and more downsizing in comparison with the patterning with a two-layer photoresist used. Accordingly, the read core width can be controlled with downsizing and higher precision.

The magnetoresistive effect film cap layer 18 and the magnetoresistive effect film 16 are etched, e.g., with CO gas with NH₃ added, at a 30 sccm flow rate of CO gas and a 70 sccm flow rate of NH₃, at a 800 W source power, at a 200 W bias power, at a 0.2 Pa gas pressure, and for 220 seconds etching period of time (just etching: 185 seconds). Under these conditions, the etching rate of the magnetoresistive effect film cap layer 18 and the magnetoresistive effect film 16 is about 0.252 nm/sec, and the etching rate of the etching resistant film 14 is 0.036 nm/sec. The etching selectivity ratio to the etching resistant film 14 can be about 7. According to this etching, the polishing resistant film 20 is etched by about 8 nm into an about 22 nm-thickness, and the etching resistant film 14 in the magnetic domain control region is etched by about 1 nm into an about 29 nm-thickness.

The magnetoresistive effect film cap layer 18 and the magnetoresistive effect film 16 may be etched by ion milling in place of reactive ion etching. For the ion milling, conditions can be, e.g., a 300 mA beam current, a 300 V beam voltage and a 0 degree Ar⁺ irradiation angle. Under these conditions, the etching rate of the anti-ferromagnetic layer of, e.g., PdPtMn film is about 21 nm/sec, and the etching rate of the etching resistant film 14 of, e.g., Ta is about 4.5 nm/sec. The etching selectivity ratio can be about 4.7.

The, the insulating film 22 of, e.g., a 7 nm-thickness Al₂O₃ film is formed on the entire surface by, e.g., sputtering method (FIG. 2C). The insulating film 22 is to insulate the lower electrode 12 from the upper electrode to be formed in a later step.

Next, a 5 nm-thickness CrTi film and a 25 nm-thickness CoCrPt film, for example, are deposited on the entire surface by, e.g., sputtering method to form the magnetic domain control film 24 of the CrTi film and the CoCrPt film.

Next, a 5 nm-thickness Ru film, for example, is deposited on the entire surface by, e.g., sputtering method to form the magnetic domain control film cap layer 26 of the Ru film (FIG. 2D).

Next, a photoresist film 28 is formed by photolithography in the region except the MR element region and the magnetic domain control region.

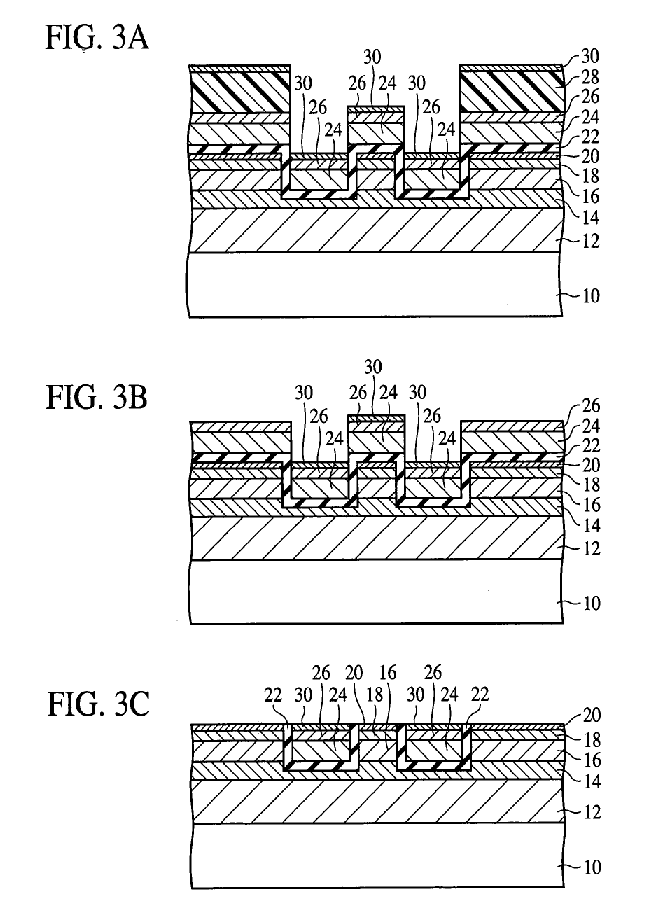

Then, a 16 nm-thickness Ta film, for example, is deposited on the entire surface by, e.g., sputtering method to form the polishing resistant film 30 of the Ta film (FIG. 3A). The polishing resistant film 30 is to be the stopper film for CMP process for forming the magnetic domain control film 24. To this end, the polishing resistant film 30 is formed of a material having polishing selectivity with respect to a magnetic material forming the magnetic domain control film 24.

Here, the film thickness of the polishing resistant film 30 is suitably set so that the height of the surface of the polishing resistant film 30 in the magnetic domain control region is equal to the height of the surface of the polishing resistant film 20 in the MR element region. In the above, in the MR element region, the film thickness of the etching resistant film 14 is 30 nm, the film thickness of the magnetoresistive effect film 16 is 30 nm, the film thickness of the magnetoresistive effect film cap layer 18 is 5 nm, the film thickness of the polishing resistant film 20 is 22 nm, and the thickness from the surface of the lower electrode 12 to the surface of the polishing resistant film 20 is 87 nm. In the magnetic domain control region, the film thickness of the etching resistant film 14 is 29 nm, the film thickness of the insulating film 22 is 7 nm, the film thickness of the magnetic domain control film 24 is 30 nm, the film thickness of the magnetic domain control film cap layer 26 is 5 nm, and the thickness from the surface of the lower electrode 12 to the surface of the magnetic domain control cap layer 26 is 71 nm. Then, the film thickness of the polishing resistant film 30 is set at 16 nm so that the thickness from the surface of the lower electrode 12 to the surface of the polishing resistant film 30 is 87 nm.

As described above, in the method for fabricating the magnetic head according to the present embodiment, the etching resistant film 14 is provided below the magnetoresistive effect film 16 to thereby control with high precision the etched film thickness in the magnetic domain control region. Thus, the film thickness of the polishing resistant film 30 is controlled, whereby the height of the surface of the polishing resistant film 20 in the MR element region and the height of the surface of the polishing resistant film 30 in the magnetic domain control region can be easily made equal to each other.

Then, the polishing resistant film 30 in the region except the MR element region and the magnetic domain control region is lifted off together with the photoresist film 28 to be left selectively in the MR element region and the magnetic domain control region (FIG. 3B).

Next, by CMP method using as the stopper the polishing resistant film 20 formed in the region except the magnetic domain control region and the polishing resistant film 30 formed in the magnetic domain control region, the magnetic domain control film cap layer 26, the magnetic domain control film 24 and the insulating film 22 formed in the region except the magnetic domain control region are polished back (FIG. 3C).

At this time, the polishing cloth may easily enter the recess of the magnetic domain control region, and even under the presence of the polishing resistant film 30 formed on the surface of the MR element region, the polishing rate in the MR element region becomes higher. However, because of the polishing resistant film 30 formed on the magnetic domain control film cap layer 26, it never happen that the magnetic domain control film cap layer 26 and the magnetic domain control film 24 are polished to resultantly cause dishing. Control is made so that the height of the surface of the polishing resistant film 20 in the MR element region and the height of the surface of the polishing resistant film 30 become equal to each other. Accordingly, the polishing in the MR element region can be also stopped with good precision by the polishing resistant film 20 on the magnetoresistive effect film cap layer 18, and the general height of the element can be flat.

The polishing resistant film 30 has also the function of preventing the occurrence of residues of Pt of the CoCrPt film forming the magnetic domain control film 24 and the over-polishing of the magnetic domain control film 24. When the magnetic domain control film 24 is polished without forming the polishing resistant film 30, Pt in the CoCrPt film forming the magnetic domain control film 24, whose polishing rate is lower than Co and Cr, tends to remain as Pt residues 36 especially near the boundary between the magnetoresistive effect film 16 and the magnetic domain control film 14, where steps are formed (see FIGS. 5A to 5C). The Pt residues 36 can be removed by over-polishing, but when the over-polishing is made, hollows (dishing) are formed on the surface of the magnetic domain control region (see FIG. 5D). Unless the over-polishing is made, the Pt residues 36 remain on the magnetoresistive effect film 16, the resistance value of the magnetoresistive effective element is increased, resultantly causing a problem of increasing the head noise.

As in the present embodiment, the polishing resistant film 30 is formed, whereby the polishing resistance of the magnetic domain control region can be increased, and resultantly, while the dishing of the magnetic domain control region is prevented, the over-polishing of the magnetic domain control film 24 can be done, and the Pt residues 36 are prevented from remaining on the magnetoresistive effect film 16, etc.

In polishing the magnetic domain control film cap layer 26, the magnetic domain control film 24 and the insulating film 22, a selective slurry whose polishing rate is higher for the Ru film forming magnetic domain control film cap layer 26, the CoCrPt film forming the magnetic domain control film 24 and the Al₂O₃ film forming the insulating film 22 than for the Ta film forming the polishing resistant films 20, 30 is used. Such slurry can be, e.g., a strong acid slurry using alumina as the abrasives, or others can be used.

The CMP of the magnetic domain control film cap layer 26, the magnetic domain control film 24 and the insulating film 22 are made, e.g., at a 200 g/cm² pressure, a 30 rpm/30 rpm rotation number and for 71 seconds of polishing period of time (just polishing: 62 seconds). Under these conditions, the polishing rate of the magnetic domain control film cap layer 16 and the magnetic domain control film 24 is about 41.4 nm/min, the polishing rate of the insulating film 22 is 136.8 nm/min, and the polishing rate of the polishing resistant films 20, 30 is 0.81 nm/min. The polishing selectivity ratio to the polishing resistant films 20, 30 can be about 51.

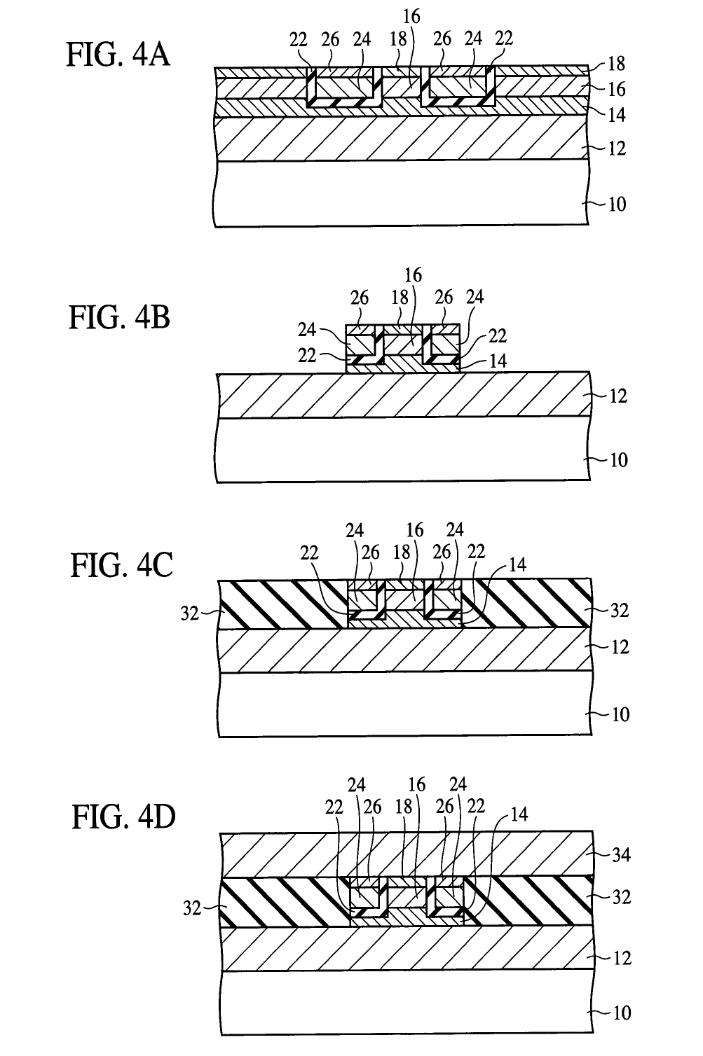

Then, the polishing resistant films 20, 30 are etched selectively to the magnetoresistive effect film cap layer 18 and the magnetic domain control film cap layer 26 by, e.g., reactive ion etching (FIG. 4A). The use of the reactive ion etching can remove the polishing resistant films 20, 30 while ensuring high selectivity to the magnetoresistive effect film cap layer 18 and the magnetic domain control film cap layer 26. Thus, read gap can be controlled with high precision.

The etching of the polishing resistant films 20, 30 are made, e.g., with CF₄ gas with Ar added, at a 20 sccm flow rate of the CF₄ gas and a 20 sccm flow rate of the Ar gas, at a 200 W source power, at a 20 W bias power, at a 1.5 Pa gas pressure and for 70 seconds of etching period of time (just etching: 47 seconds). Under these conditions, the etching rate of the polishing resistant films 20, 30 of Ta is about 0.85 nm/sec, and the etching rate of the magnetoresistive effect film cap layer 18 and the magnetic domain control film cap layer 26 of Ru is 0.073 nm/sec. The etching selectivity ratio to the magnetoresistive effect film cap layer 18 and the magnetic domain control film cap layer 26 can be about 11.6.

Then, by photolithography and dry etching, the magnetic domain control film cap layer 26, the magnetoresistive effect film cap layer 18, the magnetoresistive effect film 16 and the insulating film 22 in the region except the MR element region and the magnetic domain control region are removed (FIG. 4B).

Then, an Al₂O₃ film, for example, is deposited by, e.g., sputtering method and then polished by CMP method until the surfaces of the magnetoresistive effect film cap layer 18 and the magnetic domain control film cap layer 26 are exposed, to thereby fill the insulating film 32 of the Al₂O₃ film in the region except the region for the element to be formed in (FIG. 4C).

Then, an NiFe film of, e.g., a 1 μm-thickness is formed on the entire surface by, e.g., sputtering method to form the upper electrode 34 of the NiFe film functioning also as the upper shield is formed, and the magnetic head according to the present embodiment is completed (FIG. 4D).

As described above, according to the present embodiment, the magnetoresistive effect film is patterned by using a single-layer photoresist and reactive ion etching, whereby in comparison with patterning the magnetoresistive effect film by using a two-layer photoresist and ion milling, fine and high-precision processing can be enable. Resultantly, the read core width of the magnetic head can be controlled with downsizing and higher precision.

The polishing resistant film has been formed in the MR element region when the magnetic domain control film is deposited on the entire surface and polished by CMP and the magnetic domain control film is formed on both sides of the magnetoresistive effect film, whereby the polishing of the MR element region by the CMP can be prevented. Thus, the read gap of the magnetic head can be controlled with high precision.

The polishing resistant film is formed selectively also on the magnetic domain control film in the magnetic domain control region, and the height of the surface of the polishing resistant film in the MR element region and the height of the surface of the polishing resistant film in the magnetic domain control region are made equal to each other, whereby the dishing of the magnetic domain control region can be prevented. Thus, the flatness of the element to be fabricated can be improved. Resultantly, the read gap of the magnetic head can be controlled with higher precision.

### A Second Embodiment

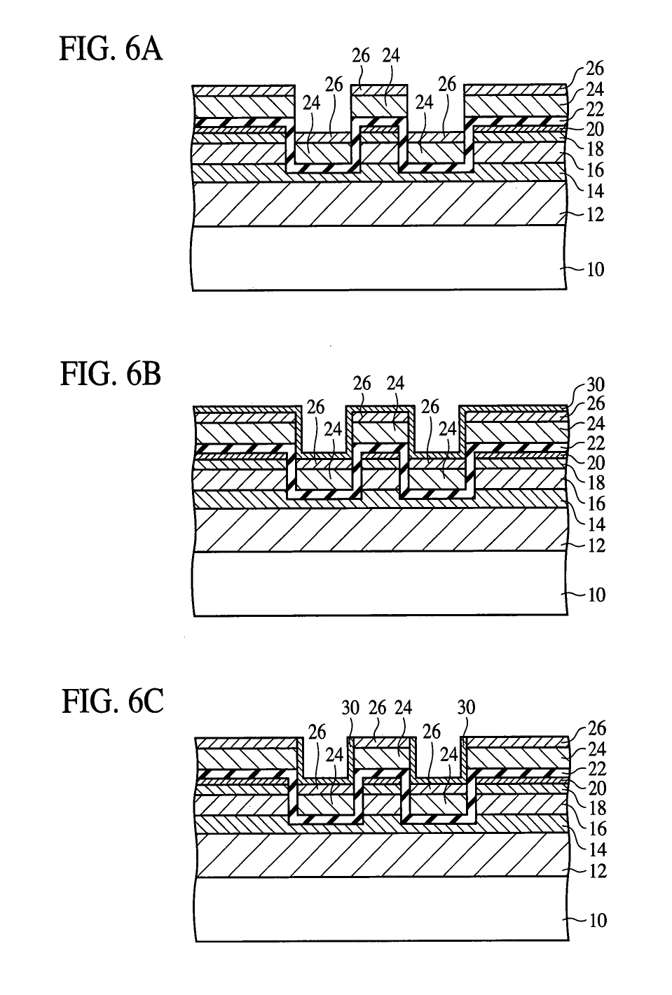

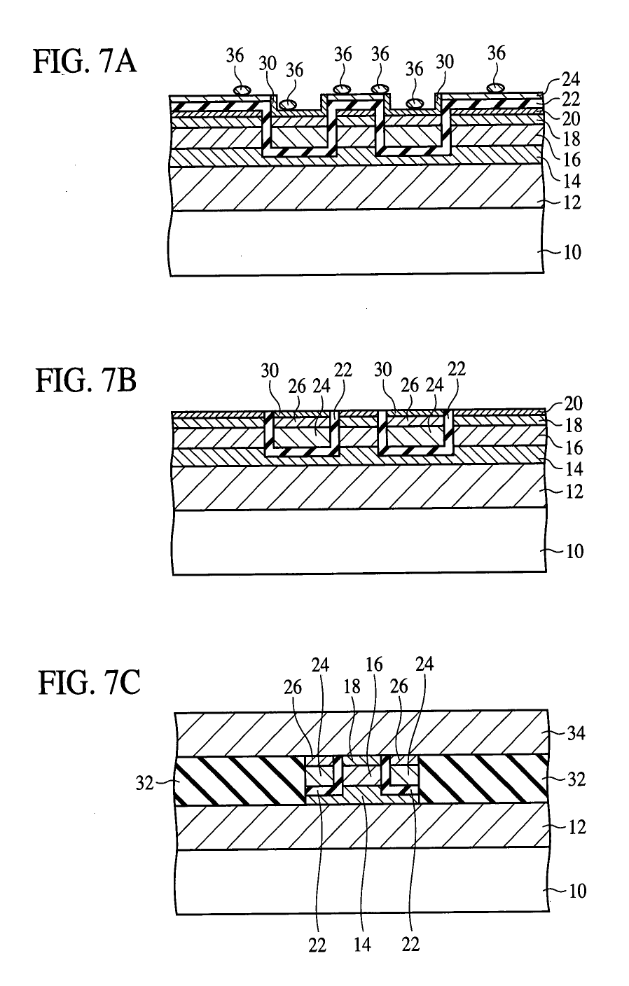

The method for fabricating the magnetic head according to a second embodiment of the present invention will be explained with reference to FIGS. 6A to 7C. The same members of the present embodiment as those of the magnetic head and the method for fabricating the same according to the first embodiment shown in FIGS. 1 to 4D are represented by the same reference numbers not to repeat or to simplify their explanation.

FIGS. 6A to 7C are sectional views of the magnetic head according to the present embodiment in the steps of the method for fabricating the magnetic head.

In the present embodiment, another method for fabricating the magnetic head according to the first embodiment shown in FIG. 1 is explained.

First, in the same way as in the method for fabricating the magnetic head according to the first embodiment, which is shown in FIGS. 2A to 2D, the lower electrode 12, the etching resistant film 14, the magnetoresistive effect film 16, the magnetoresistive effect film cap layer 18, the polishing resistant film 20, the insulating film 22, the magnetic domain control film 24 and the magnetic domain control film cap layer 26 are formed over the substrate 10 (FIG. 6A).

Then, a Ta film of, e.g., a 16 nm-thickness is deposited over the entire surface by, e.g., sputtering method to form the polishing resistant film 30 of the Ta film (FIG. 6B). The polishing resistant film 30 is used as the stopper for CMP in forming the magnetic domain control film 24. To this end, the polishing resistant film 30 is formed of a material having polishing selectivity to the magnetic material forming the magnetic domain control film 24. The film thickness of the polishing resistant film 30 is set by the same method as in the first embodiment.

Then, the polishing resistant film 30 formed in the region except the magnetic domain control region is selectively polished by CMP with the magnetic domain control film cap layer 26 as the stopper (FIG. 6C).

In polishing the polishing resistant film 30, a selective slurry having a higher polishing rate for the Ta film forming the polishing resistant film 30 than for the Ru film forming the magnetic domain control film cap layer 26 is used. Such slurry can be, e.g., a weak acid slurry using alumina as the abrasives, or others. The CMP for the polishing resistant film 30 is made, e.g., under a 20 kPa pressure and at a 100 rpm rotation number.

Then, the magnetic domain control film cap layer 26, the magnetic domain control film 24 and the insulating film 22 formed in the region except the magnetic domain control region are polished back by CMP with the polishing resistant film 20 formed in the region except the magnetic domain control region and the polishing resistant film 30 formed in the magnetic domain control region.

In polishing the magnetic domain control film cap layer 26, the magnetic domain control film 24 and the insulating film 22, a selective slurry whose polishing rate is higher for the Ru film forming the magnetic domain control film cap layer 26, the CoCrPt film forming the magnetic domain control film 24 and the Al₂O₃ film forming the insulating film 22 than for the Ta film forming the polishing resistant films 20, 30, as is not the slurry for polishing the magnetic domain control film cap layer 26. Such slurry can be, e.g., a strong acid slurry using alumina as the abrasives, or others.

The CMP of the magnetic domain control film cap layer 26, the magnetic domain control film 24 and the insulating film 22 are made, e.g., at a 200 g/cm² pressure, a 30 rpm/30 rpm rotation number and for 71 seconds of polishing period of time (just polishing: 62 seconds). Under these conditions, the polishing rate of the magnetic domain control film cap layer 16 and the magnetic domain control film 24 is about 41.4 nm/min, the polishing rate of the insulating film 22 is 136.8 nm/min, and the polishing rate of the polishing resistant films 20, 30 is 0.81 nm/min. The polishing selectivity ratio to the polishing resistant films 20, 30 can be about 51.

In the process of polishing the magnetic domain control film 24, as shown in FIG. 7A, residues 36 of Pt are often made. However, the polishing resistant film 20 formed over the magnetoresistive effect film cap layer 18 and the polishing resistant film 30 formed over the magnetic domain control film cap layer 26 permits over-polishing to be sufficiently made, and the magnetic domain control film cap layer 26, the magnetic domain control film 24 and the insulating film 22 formed in the region except the magnetic domain control region can be removed without the Pt residues 36 (FIG. 7B).

As described above, the CMP is made in the two stages using a selective slurry whose polishing rate is higher for the constituent material of the polishing resistant film 30 (e.g., Ta) than for the constituent material of the magnetic domain control film cap layer 26 (e.g., Ru), and a selective slurry whose polishing rate is higher for the constituent material of the magnetic domain control film cap layer 26 (e.g., Ru), the constituent material of the magnetic domain control film 24 (e.g., CoCrPt) and the constituent material of the insulating film 22 (e.g., Al₂O₃) than for the constituent material of the polishing resistant films 20, 30 (e.g., Ta), whereby the polishing resistant film 30 can be formed easily in comparison with the first embodiment.

That is, in the first embodiment, the polishing resistant film 30 is formed by the lift off using the photoresist film 28 selectively in the MR element region and the magnetic domain control region. When a misalignment takes place in the process of forming the photoresist film 28, an inconvenience that the polishing resistant film 30 remains in the region where properly the polishing resistant film 30 should not remain, and resultantly regions which cannot be polished in the CMP process will take place. In the method according to the present embodiment, the polishing resistant film 30 can be formed in the magnetic domain control region by self-alignment in the first polishing step, whereby the occurrence of the inconvenience can be effectively prevented in the second polishing step.

Next, in the same way as in the method for fabricating the magnetic head according to the first embodiment, which is shown in FIGS. 4A to 4D, the polishing resistant films 20, 30 are removed, the magnetic domain control film cap layer 26, the magnetoresistive effect film cap layer 18, the magnetoresistive effect film 16 and the insulating film 22, etc. formed in a region except the MR element region and the magnetic domain control region are removed, and the insulating film 32 and the upper electrode 34 are formed. And the magnetic head shown in FIG. 1 is completed (FIG. 7C).

As described above, according to the present embodiment, in depositing the magnetic domain control film over the entire surface and polishing the magnetic domain control film by CMP to thereby bury to form the magnetic domain control film on both sides of the magnetoresistive effect film, the polishing resistant film is formed over the entire surface, then the polishing resistant film formed in the region except the magnetic domain control region is selectively removed in the first polishing step, and in the second polishing step, the magnetic domain control film formed in the region except the magnetic domain control region is selectively removed with the polishing resistant film as the stopper, whereby the polishing resistant film can be formed by self-alignment in the magnetic domain control region. This facilitates the polishing step of burying to form the magnetic domain control film.

The polishing resistant film is formed over the MR element region and over the magnetic domain control film in the magnetic domain control region, whereby inconveniences that, in the CMP, the MR element region is polished and dishing takes place in the magnetic domain control region can be prevented. Thus, the read gap of the magnetic head can be controlled with high precision, and the elements can be formed, more planarized, which permits the read gap of the magnetic head to be controlled with higher precision.

### Third Embodiment

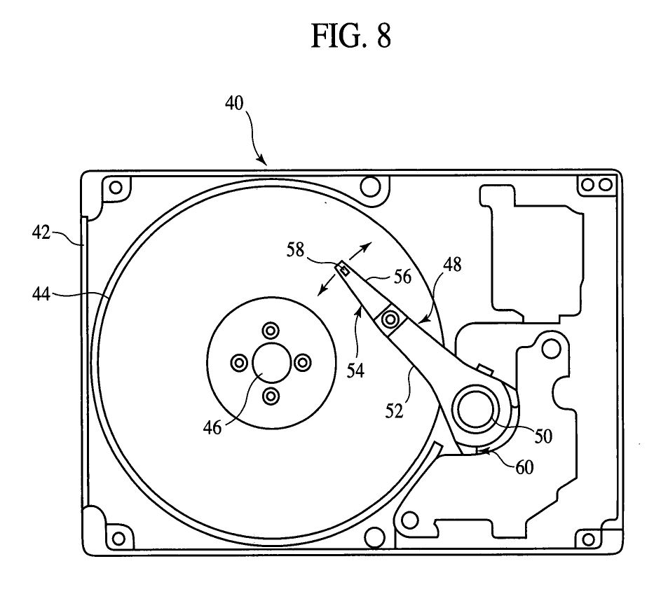

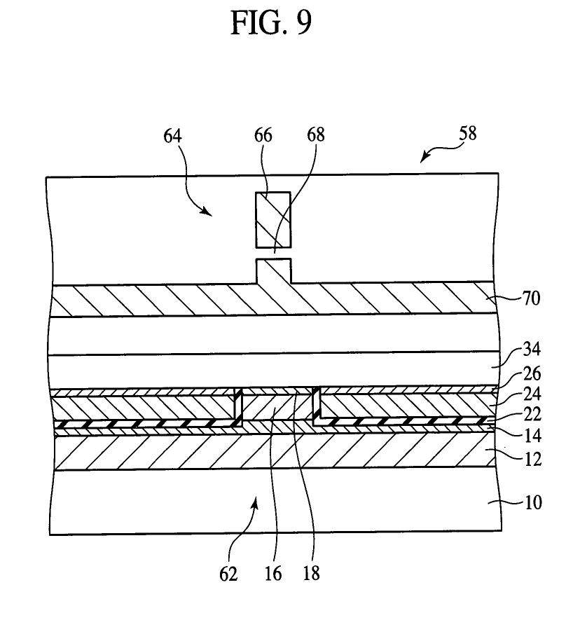

The magnetic recording device according to a third embodiment of the present invention will be explained with reference to FIGS. 8 and 9. The same members of the present embodiment as those of the magnetic head according to the first and the second embodiments shown in FIGS. 1 to 7C are represented by the same reference numbers not to repeat or to simplify their explanation.

FIG. 8 is a diagrammatic plan view of the magnetic recording device according to the present embodiment. FIG. 9 is a front view of the magnetic head of the magnetic recording device according to the present embodiment.

First, the structure of the magnetic recording device according to the present embodiment will be explained with reference to FIG. 8.

The magnetic recording device 40 according to the present embodiment includes a box body 42 defining, e.g., a lengthy cuboid interior space. The housing space accommodates one or more magnetic discs 44 as the recording media. The magnetic disc 44 is mounted on the rotary shaft of a spindle motor 46. The spindle motor 46 can rotate the magnetic disc 44 at a high speed of, e.g., 7200 rpm or 10000 rpm. A cover (not shown) is connected to the box body 42, for tightly closing the housing space in cooperation of the box body 42.

The housing space further accommodates a head actuator 48. The head actuator 48 is rotatably mounted on a support shaft 50 which is vertically extended. The head actuator 48 includes a plurality of actuator arms 52 horizontally extended from the support shaft 50, and head suspension assemblies 54 mounted on the forward ends of the respective actuator arms 52 and extended forward from the actuator arms 52. The actuator arms 52 are provided for the front side and the underside of the magnetic disc 44.

Each head suspension assembly 54 includes a loadbeam 56. The loadbeam 56 is connected to the forward end of the actuator arm 52 at the so-called elastically bendable area. The elastically bendable area exerts a prescribed urging force to the forward end of the loadbeam 56 toward the surface of the magnetic disc 44. A magnetic head 58 is supported on the forward end of the loadbeam 56. The magnetic head 58 is received free to change the posture by a gimbal (not shown) secured to the loadbeam 56.

When the rotation of the magnetic disc 44 generates air flow on the surface of the magnetic disc 44, the air flow causes a positive pressure, i.e., a buoyancy and a negative pressure to act on the magnetic heads 58. The buoyancy, the negative pressure and the urging force of the loadbeam 56 are balanced to keep the magnetic head 58 buoyant with relatively high rigidity during the magnetic disc 44 is rotating.

The actuator arms 52 are connected to a drive source 60, e.g., a voice coil motor (VCM). The drive source 60 rotates the actuator arms 52 on the support shaft 50. Such rotation of the actuator arms 52 permits the head suspension assembly 54 to move. When the support shaft 50 is rotated to swing the actuator arm 52 while the magnetic head 58 is buoyant, the magnetic head 58 can radially traverse the surface of the magnetic disc 44. Such movement permits the magnetic head 58 to be positioned at a required recording track on the magnetic disc 44.

Next, the magnetic head 58 of the magnetic recording device according to the present embodiment will be detailed with reference to FIG. 9.

As shown in FIG. 9, the magnetic head 58 having a reproduction head 62 formed of a magnetoresistive effect element and a recording head formed of an induction-type writing element generally comprises the production head 62 and the recording head 64 sequentially laid on a flat substrate 10 of Al₂O₃—TiC (AlTiC) to be the base of the head slider which are covered with an insulator of alumina or others.

The reproduction head 62 is the magnetic head according to, e.g., the first embodiment of the present invention and comprises the lower electrode 12 formed on the substrate 10, the etching resistant film 14 formed on the lower electrode 12, the magnetoresistive effect film 16 formed on the etching resistant film 14, the magnetoresistive effect film cap layer 18 formed on the magnetoresistive effect film 16, the upper electrode 34 formed on the magnetoresistive effect film cap layer 18, and the magnetic domain control film 24 provided on both sides of the magnetoresistive effect film 16 with the insulating film 22 formed therebetween.

The lower electrode 12 and the upper electrode 34 have the function of the magnetic shield in addition to the function of the path of the sense current. The magnetoresistive effect film 16 is a magnetoresistive effect film of the spin valve structure of, e.g., the first embodiment. The magnetic domain control film 24 defines the pinned magnetization layer and the free magnetization layer of the magnetoresistive effect film 16 in a single magnetization domain and is for preventing the generation of Barkhausen noises.

The recording head 64 includes on the surface opposed to the magnetic disc 44 an upper magnetic pole 66 of a width corresponding to a track width, a lower magnetic pole 70 opposed with a non-magnetic gap layer 68 provided therebetween, a yoke (not shown) connected to the upper magnetic pole 66 and the lower magnetic pole 70, a coil (not shown) wound on the yoke, etc. The upper magnetic pole 66, the lower magnetic pole 68 and the yoke are formed of a material of a soft magnetic material of high saturation flux density for ensuring the recording magnetic field, suitably, e.g., Ni₈₀Fe₂₀, CoZrNb, FeN, FeSiN, FeCo alloy or others.

The writing in the magnetic disc 44 by the magnetic head 58 is made with the recording head 64. That is, magnetic field leaking between the upper magnetic pole 66 and the lower magnetic pole 70 records the information in the magnetic disc 44 in a region opposed to the recording head 64.

The reproduction of the information written in the magnetic disc 44 is made by the reproduction head 62. That is, magnetic field leaking based on the information recorded in the magnetic disc 44 is detected as resistance changes of the magnetoresistive effect film 16 to thereby read the information recorded in the magnetic disc 44.

As described above, according to the present embodiment, the magnetic recording device includes the magnetic head according to the first embodiment, whereby the read core width and read gap of the reproduction head can be controlled to be downsized with high precision. Thus, the recording density and yield of the magnetic recording device can be increased.

### Modified Embodiments

The present invention is not limited to the above-described embodiments and can cover other various modifications.

For example, in the first embodiment described above, the polishing resistant films 20, 30 are formed to thereby the over-polishing of the MR element region and dishing of the magnetic domain control region are prevented in the polishing. However, the polishing resistant film 30 is not essentially necessary, and in this case, dishing will take place in the magnetic domain control region. However, the over-polishing of the MR element region can be prevented, and read gap can be controlled with high precision.

In the first embodiment described above, the etching resistant film 14 is formed below the magnetoresistive effect film 16. However, the etching resistant film 14 is not essentially necessary. The etching resistant film 14 is for etching the magnetoresistive effect film 16 selectively to the lower electrode 12. In a case that even without the presence of the etching resistant film 14, the etching of the magnetoresistive effect film 16 can be stopped with good precision, e.g., by selecting the forming material or other means, the etching resistant film 14 may not be provided.

The material forming the respective layers of the magnetic head are not limited to those described in the above-described embodiments and can be suitably changed.

What is claimed is:

1. A method for fabricating a magnetic head comprising the steps of:
forming over a first region of a lower electrode a magnetoresistive effect film with a first polishing resistant film formed over an upper surface, the first polishing resistant film having a polishing selectivity to a magnetic material;
forming a magnetic domain control film over an entire surface of the lower electrode including the first region;
removing the magnetic domain control film over the magnetoresistive effect film by polishing with the first polishing resistant film as a stopper to leave the magnetic domain control film selectively in a second region adjacent to the first region;
removing the first polishing resistant film; and
forming an upper electrode over the magnetoresistive effect film from which the first polishing resistant film has been removed.

2. The method for fabricating a magnetic head according to claim 1,
further comprising, after the step of forming the magnetic domain control film, the step of forming a second polishing resistant film having a polishing selectivity to a magnetic material over the magnetic domain control film, wherein
in the step of polishing the magnetic domain control film, the magnetic domain control film is polished with the first polishing resistant film and the second polishing resistant film as a stopper, and
in the step of removing the first polishing resistant film, the first polishing resistant film and the second polishing resistant film are removed.

3. The method for fabricating a magnetic head according to claim 2, wherein
in the step of forming the second polishing resistant film, a film thickness of the second polishing resistant film is so set that a height of a surface of the second polishing resistant film is equal to a height of a surface of the first polishing resistant film formed over the magnetoresistive effect film.

4. The method for fabricating a magnetic head according to claim 2, wherein
in the step of forming the second polishing resistant film, the second polishing resistant film is formed selectively in the first region and the second region.

5. The method for fabricating a magnetic head according to claim 2, wherein
in the step of forming the second polishing resistant film, the second polishing resistant film is formed over the entire surface including the first region and the second region, and
the step of polishing the magnetic domain control film includes a first polishing step of selectively removing the second polishing resistant film formed in the region except the second region, and a second polishing step of selectively removing the magnetic domain control film formed in the region except the second region.

6. The method for fabricating a magnetic head according to claim 5, wherein
in the first polishing step and the second polishing step, slurries of different polishing characteristics are used.

7. The method for fabricating a magnetic head according to claim 1, wherein
the step of forming the magnetoresistive effect film includes the steps of:
forming over the lower electrode an etching resistant film having an etching selectivity to the magnetoresistive effect film;
forming the magnetoresistive effect film over the etching resistant film;
forming the first polishing resistant film over the magnetoresistive effect film; and
etching the first polishing resistant film and the magnetoresistive effect film with the etching resistant film as a stopper.

8. The method for fabricating a magnetic head according to claim 7, wherein
in the step of etching the first polishing resistant film and the magnetoresistive effect film, the first polishing resistant film and the magnetoresistive effect film are etched by using a single-layer photoresist.

9. The method for fabricating a magnetic head according to claim 7, wherein
in the step of etching the first polishing resistant film and the magnetoresistive effect film, the first polishing resistant film and the magnetoresistive effect film are etched by reactive ion etching.

10. The method for fabricating a magnetic head according to claim 1, wherein
in the step of removing the first polishing resistant film, the first polishing resistant film is removed by reactive ion etching.

11. The method for fabricating a magnetic head according to claim 1, wherein
in the step of forming the magnetoresistive effect film, the magnetoresistive effect film with a cap layer of a non-magnetic material formed over the upper surface is formed.

12. The method for fabricating a magnetic head according to claim 1, wherein
in the step of forming the magnetic domain control film, the magnetic domain control film with a cap layer of a non-magnetic material formed over an upper surface is formed.

13. The method for fabricating a magnetic head according to claim 1, wherein
in the step of forming the magnetic domain control film, the magnetic domain control film is formed after an insulating film is formed over the entire surface of the lower electrode including the region where the magnetoresistive effect film has been formed.
